(19) United States
(12) Patent Application Publication
(10) Pub. No.: US 2020/0154636 A1
(43) Pub. Date: May 21, 2020

(54) REVERSIBLE LAWN MOWER BLADE

(71) Applicant: Kevin Harvey, Palacios, TX (US)

(72) Inventor: Kevin Harvey, Palacios, TX (US)

(21) Appl. No.: 16/191,681

(22) Filed: Nov. 15, 2018

(51) Int. Cl. A01D 34/73; A01D 34/67

(52) U.S. Cl. CPC A01D 34/73; A01D 2101/00; A01D 34/67

(57) ABSTRACT

A reversible lawn mower blade assembly includes a lawn mower that has an output shaft. A hub is removably coupled to the output shaft such that the output shaft rotates the hub when the lawn mower is turned on. The hub has a plurality of protrusions thereon radiating outwardly from a center of the hub. A plurality of blades is provided and each of the blades is removably coupled to a respective one of the protrusions such that the hub rotates the blades when the lawn mower is turned on. Each of the blades has a first cutting edge and a second cutting edge. Moreover, each of the blades is reversible on the hub such that a selected one of the first or second cutting edges faces the direction of the hub's rotation thereby enhancing a service life of the blades with respect to cutting.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to reversible blade devices and more particularly pertains to a new reversible blade device for extending the service life of lawn mower blades.

### BRIEF SUMMARY OF THE INVENTION

An embodiment of the disclosure meets the needs presented above by generally comprising a lawn mower that has an output shaft. A hub is removably coupled to the output shaft such that the output shaft rotates the hub when the lawn mower is turned on. The hub has a plurality of protrusions thereon radiating outwardly from a center of the hub. A plurality of blades is provided and each of the blades is removably coupled to a respective one of the protrusions such that the hub rotates the blades when the lawn mower is turned on. Each of the blades has a first cutting edge and a second cutting edge. Moreover, each of the blades is reversible on the hub such that a selected one of the first or second cutting edges faces the direction of the hub's rotation thereby enhancing a service life of the blades with respect to cutting.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom side view of a reversible lawn mower blade assembly according to an embodiment of the disclosure.

FIG. 2 is a top phantom view of a hub and a plurality of blades of an embodiment of the disclosure.

FIG. 3 is a front view of a hub and a plurality of blades of an embodiment of the disclosure.

FIG. 4 is a cross sectional view taken along line 4-4 of FIG. 2 of an embodiment of the disclosure.

FIG. 5 is a top perspective view of a hub of an embodiment of the disclosure.

FIG. 6 is a top perspective view of a hub of an alternative embodiment of the disclosure.

FIG. 7 is a front view of a hub and a plurality of blades of an alternative embodiment of the disclosure.

### DETAILED DESCRIPTION OF THE INVENTION

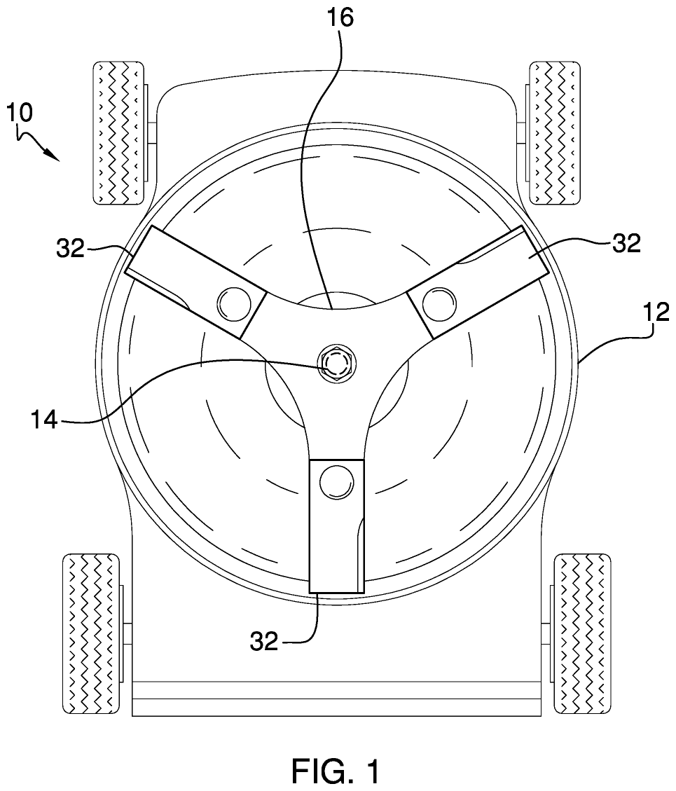

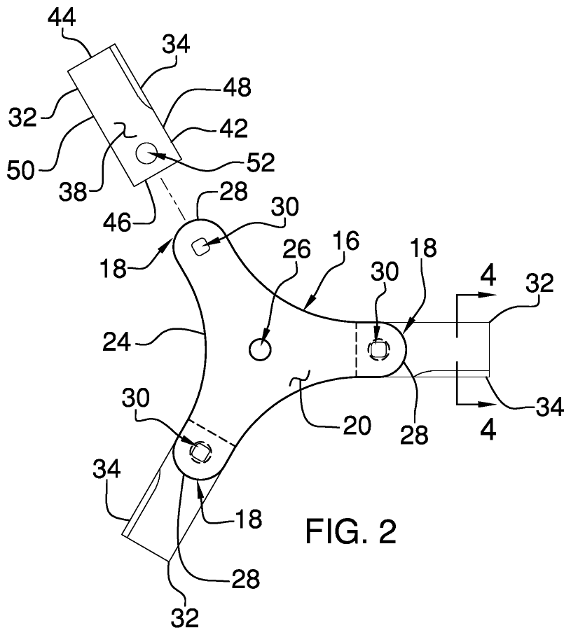

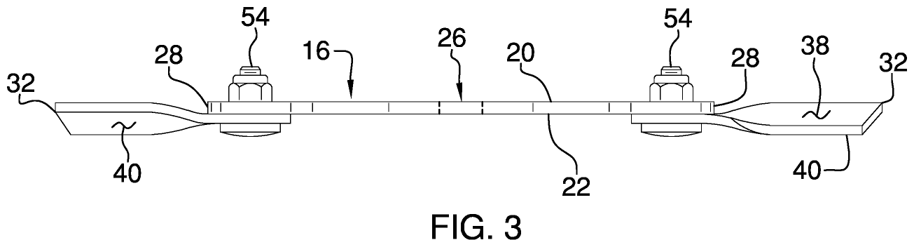

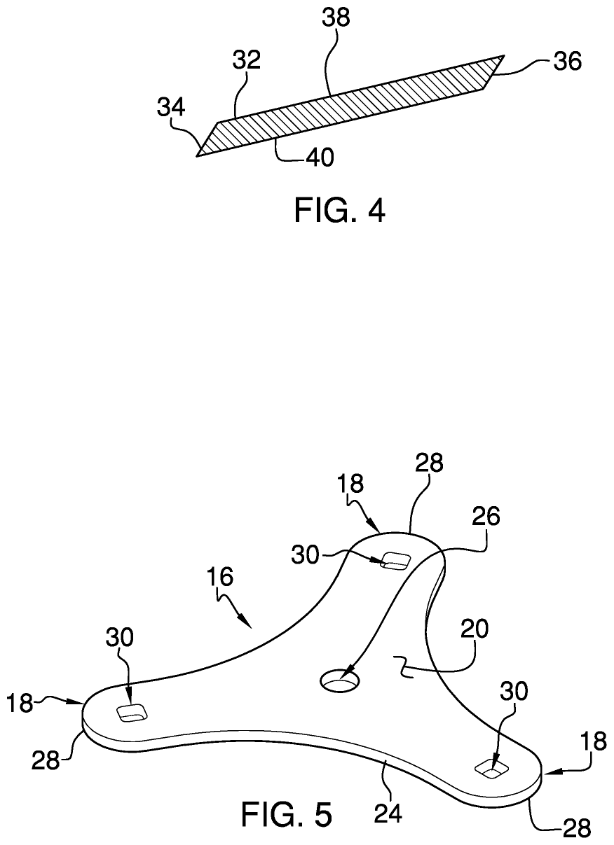

With reference now to the drawings, and in particular to FIGS. 1 through 7 thereof, a new reversible blade device embodying the principles and concepts of an embodiment of the disclosure and generally designated by the reference numeral 10 will be described.

As best illustrated in FIGS. 1 through 7, the reversible lawn mower blade assembly 10 generally comprises a lawn mower 12 that has an output shaft 14. The lawn mower 12 may be a gas powered push mower of any conventional design or a gas powered riding lawn mower 12 of any conventional design. Additionally, the lawn mower 12 may be an electric lawn mower 12 of any conventional design. A hub 16 is removably coupled to the output shaft 14 such that the output shaft 14 rotates the hub 16 when the lawn mower 12 is turned on. The hub 16 has a plurality of protrusions 18 thereon radiating outwardly from a center of the hub 16.

The hub 16 has a top surface 20, a bottom surface 22 and a perimeter edge 24 extending outwardly therefrom, the hub 16 has a mounting aperture 26 extending through the top 20 and bottom 22 surfaces and the mounting aperture 26 is centrally positioned on the hub 16. The perimeter edge 24 alternatively curves outwardly from the mounting aperture 26 and inwardly toward the mounting aperture 26 to define the plurality of protrusions 18. The protrusions 18 are evenly spaced apart from each other such that the hub 16 has a triangular cross section taken along a line extending through the top 20 and bottom 22 surfaces. Each of the protrusions 18 has a distal end 28 with respect to the mounting aperture 26. The hub 16 has a plurality of blade apertures 30 each extending through the top 20 and bottom 22 surfaces of the hub 16. Each of the blade apertures 30 is positioned on a respective one of the protrusions 18 and each of the blade apertures 30 is spaced from the distal end 28 of the respective protrusion 18.

A plurality of blades 32 is provided and each of the blades 32 is removably coupled to a respective one of the protrusions 18 such that the hub 16 rotates the blades 32 when the lawn mower 12 is turned on. Each of the blades 32 has a first cutting edge 34 and a second cutting edge 36. Additionally, each of the blades 32 is reversible on the hub 16 such that a selected one of the first 34 or second 36 cutting edges faces the direction of the hub's 16 rotation. In this way the service life of each of the blades 32 is enhancing with respect to cutting grass.

Each of the blades 32 has a primary surface 38, a secondary surface 40 and an outer edge 42 extending therebetween, and the outer edge 42 of each of the blades 32 has a first lateral side 44, a second lateral side 46, a front side 48 and a back side 50. Each of the blades 32 is elongated between the first 44 and second 46 lateral sides. The front side 48 of the outer edge 42 of each of the blades 32 has the first cutting edge 34 thereon angling downwardly from the primary 38 and secondary 40 surfaces of the blades 32. The back side 50 of the outer edge 42 of each of the blades 32 has the second cutting edge 36 thereon and angling upwardly between the secondary 40 and primary 38 surfaces of the blades 32. Each of the blades 32 may be twisted between the first 44 and second 46 lateral sides of the perimeter edge 24.

The first cutting edge 34 on each of the blades 32 faces the hub's 16 direction of rotation when the primary surface 38 of the blades 32 abuts the bottom surface 22 of the hub 16. The second cutting edge 36 on each of the blades 32 faces the hub's 16 direction of rotation when the secondary surface 40 of the blades 32 abuts the bottom surface 22 of the hub 16. Each of the blades 32 has a coupling aperture 52 extending through the primary 38 and secondary 40 surfaces and the coupling aperture 52 on each of the blades 32 is positioned closer to the first lateral side 44 of the blade 32 than the second lateral side 46 of the blade 32.

A plurality of fasteners 54 is provided and each of the fasteners 54 extends through the coupling aperture 52 in a respective one of the blades 32 and engages the blade aperture 30 in a respective one of the protrusions 18. Each of the blades 32 is oriented collinear with a line extending through the mounting aperture 26 in the hub 16 and the distal end 28 of the respective protrusion 18 when the blades 32 are coupled to the hub 16. Additionally, each of the fasteners 54 may comprise a bolt or other releasable mechanical fastener.

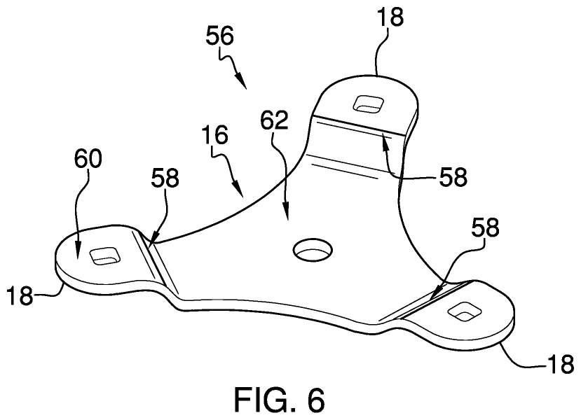

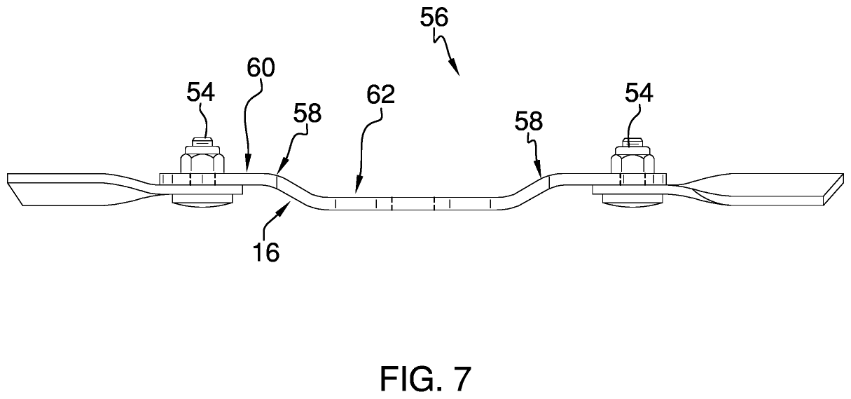

In an alternative embodiment 56 as shown in FIGS. 6 and 7, each of the protrusions 18 may have a bend 58 thereon that extends laterally across the protrusions 18. The bend 58 on each of the protrusions 18 is positioned between the distal end 28 of each of the protrusions 18 and the mounting aperture 26. Thus, the bend 58 on each of the protrusions 18 defines an end portion 60 of each of the protrusions 18 that is each offset from a central portion 62 of the hub 16. Additionally, the primary surface 38 corresponding to the end portion 60 of each of the protrusions 18 is offset from the primary surface 38 corresponding to the central portion 62 of the hub 16.

In use, the output shaft 14 is extended through the mounting aperture 26 in the hub 16 and a nut or other fastener is applied to the output shaft 14 to retain the hub 16 on the output shaft 14. Each of the blades 32 is coupled to a respective one of the protrusions 18 having the first cutting edge 34 on each of the blades 32 facing the direction of the hub 16's rotation. Respective ones of the blades 32 is reversible on the hub 16 having the second cutting edge 36 of the respective blade 32 facing the direction of the hub 16's rotation when the first cutting edge 34 of the respective blade 32 becomes dulled or damaged. In this way the service life of the respective blade 32 is enhanced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reversible lawn mower blade assembly being configured to be mounted on a lawn mower for cutting grass, said assembly comprising:
a lawn mower having an output shaft;
a hub being removably coupled to said output shaft such that said output shaft rotates said hub when said lawn mower is turned on, said hub having a plurality of protrusions thereon radiating outwardly from a center of said hub; and
a plurality of blades, each of said blades being removably coupled to a respective one of said protrusions such that said hub rotates said blades when said lawn mower is turned on, each of said blades having a first cutting edge and a second cutting edge, each of said blades being reversible on said hub such that a selected one of said first or second cutting edges faces the direction of said hub's rotation thereby enhancing a service life of said blades with respect to cutting.

2. The assembly according to claim 1, wherein said hub has a top surface, a bottom surface and a perimeter edge extending outwardly therefrom, said hub having a mounting aperture extending through said top and bottom surfaces, said mounting aperture being centrally positioned on said hub, said perimeter edge alternatively curving outwardly from said mounting aperture and inwardly toward said mounting aperture to define said plurality of protrusions, said protrusions being evenly spaced apart from each other such that said hub has a triangular cross section taken along a line extending through said top and bottom surfaces, each of said protrusions having a distal end with respect to said mounting aperture.

3. The assembly according to claim 2, wherein said hub has a plurality of blade apertures each extending through said top and bottom surfaces of said hub, each of said blade apertures being positioned on a respective one of said protrusions and being spaced from said distal end of said respective protrusion.

4. The assembly according to claim 1, wherein each of said blades has a primary surface, a secondary surface and an outer edge extending therebetween, said outer edge of each of said blades having a first lateral side, a second lateral side, a front side and a back side, each of said blades being elongated between said first and second lateral sides, said front side of said outer edge of each of said blades having said first cutting edge thereon and angling downwardly from said primary and secondary surfaces of said blades, said back side of said outer edge of each of said blades having said second cutting edge thereon and angling upwardly between said secondary and primary surfaces of said blades.

5. The assembly according to claim 3, wherein:
said first cutting edge on each of said blades faces said hub's direction of rotation when said primary surface of said blades abuts said bottom surface of said hub; and
said second cutting edge on each of said blades faces said hub's direction of rotation when said secondary surface of said blades abuts said bottom surface of said hub.

6. The assembly according to claim 5, wherein each of said blades has a coupling aperture extending through said primary and secondary surfaces, said coupling aperture on each of said blades being positioned closer to said first lateral side of said blades than said second lateral side of said blades.

7. The assembly according to claim 6, further comprising a plurality of fasteners, each of said fasteners extending through said coupling aperture in a respective one of said blades and engaging a blade aperture in a respective one of said protrusions, each of said blades being oriented collinear with a line extending through a mounting aperture in said hub and a distal end of said respective protrusion when said blades are coupled to said hub.

8. The assembly according to claim 2, wherein each of said protrusions has a bend thereon extending laterally across said protrusions, said bend on each of said protrusions being positioned between said distal end of each of said protrusions and said mounting aperture, said bend on each of said protrusions defining an end portion of each of said protrusions being each offset from a central portion of said hub, said primary surface corresponding to said end portion of each of said protrusions being offset from said primary surface corresponding to said central portion of said hub.

9. A reversible lawn mower blade assembly being configured to be mounted on a lawn mower for cutting grass, said assembly comprising:
a lawn mower having an output shaft;
a hub being removably coupled to said output shaft such that said output shaft rotates said hub when said lawn mower is turned on, said hub having a plurality of protrusions thereon radiating outwardly from a center of said hub, said hub having a top surface, a bottom surface and a perimeter edge extending outwardly therefrom, said hub having a mounting aperture extending through said top and bottom surfaces, said mounting aperture being centrally positioned on said hub, said perimeter edge alternatively curving outwardly from said mounting aperture and inwardly toward said mounting aperture to define said plurality of protrusions, said protrusions being evenly spaced apart from each other such that said hub has a triangular cross section taken along a line extending through said top and bottom surfaces, each of said protrusions having a distal end with respect to said mounting aperture, said hub having a plurality of blade apertures each extending through said top and bottom surfaces of said hub, each of said blade apertures being positioned on a respective one of said protrusions and being spaced from said distal end of said respective protrusion;
a plurality of blades, each of said blades being removably coupled to a respective one of said protrusions such that said hub rotates said blades when said lawn mower is turned on, each of said blades having a first cutting edge and a second cutting edge, each of said blades being reversible on said hub such that a selected one of said first or second cutting edges faces the direction of said hub's rotation thereby enhancing a service life of said blades with respect to cutting, each of said blades having a primary surface, a secondary surface and an outer edge extending therebetween, said outer edge of each of said blades having a first lateral side, a second lateral side, a front side and a back side, each of said blades being elongated between said first and second lateral sides, said front side of said outer edge of each of said blades having said first cutting edge thereon and angling downwardly from said primary and secondary surfaces of said blades, said back side of said outer edge of each of said blades having said second cutting edge thereon and angling upwardly between said secondary and primary surfaces of said blades, said first cutting edge on each of said blades facing said hub's direction of rotation when said primary surface of said blades abuts said bottom surface of said hub, said second cutting edge on each of said blades facing said hub's direction of rotation when said secondary surface of said blades abuts said bottom surface of said hub, each of said blades having a coupling aperture extending through said primary and secondary surfaces, said coupling aperture on each of said blades being positioned closer to said first lateral side of said blade than said second lateral side of said blade; and
a plurality of fasteners, each of said fasteners extending through said coupling aperture in a respective one of said blades and engaging said blade aperture in a respective one of said protrusions, each of said blades being oriented collinear with a line extending through said mounting aperture in said hub and said distal end of said respective protrusion when said blades are coupled to said hub.

10. The assembly according to claim 9, wherein each of said protrusions has a bend thereon extending laterally across said protrusions, said bend on each of said protrusions being positioned between said distal end of each of said protrusions and said mounting aperture, said bend on each of said protrusions defining an end portion of each of said protrusions being each offset from a central portion of said hub, said primary surface corresponding to said end portion of each of said protrusions being offset from said primary surface corresponding to said central portion of said hub.
